(19) United States
(12) Patent Application Publication
(10) Pub. No.: US 2005/0015282 A1
(43) Pub. Date: Jan. 20, 2005

(54) Transferable and tradable annuities pension and similar instruments

(76) Inventors: Michael Gutman, Kiryat Tivon (IL); Eyal Gutman, Kiryat Tivon (IL); Uri Ben-Zion, Beer Sheve (IL); Giora Teltsch, Haifa (IL)

Correspondence Address: Michael Gutman, 37 K K L Street, Kiryat Tivon, 36000, IL

(21) Appl. No.: 10/491,822

(22) PCT Filed:
(86) PCT No.: PCT/IL02/00626

(30) Foreign Application Priority Data
Aug. 6, 2001 (IL) 144738

(51) Int. Cl. G06F 17/60

(52) U.S. Cl. 705/4

(57) ABSTRACT

The invention introduces innovative elements to life-related annuities, and similar instruments (PI's) by transforming thereof from PI's issued permanently to a specific holder and priced according to a specific insured person, into PI issued initially to anonymous holders, without specific insured persons. Such PI's are convertible by any Holder, up to expiration date, to contracts similar to those under prior art, by identifying during such time specific insured Person, Beneficiaries and possibly Holder, who are identified under prior art contracts already at the issuance of such contracts. Initial purchase of such contract involves payment of an advance payment, while the balance, which is due if and after the initial contract is transformed into final contract, depends on the particulars of the identified insured persons. Until such identification, the initial contracts may change hands from one anonymous holder to another one, until the contract is activated or expired.

### FIELD OF THE INVENTION

The present invention relates to the issue, usage and trade in life related instruments such as annuities, pension schemes etc (“Pension Instruments” or “PI”).

### BACKGROUND OF THE INVENTION

Under Prior art, PI's are issued for specific holders and contain the details of specific insured persons who cannot be changed and whose particulars determine the level of premium payable under the PI policies, and any changes thereunder require the consent or agreement of the parties thereto.

Typically in PI's, as in insurance programs, the holder of the policy pays annual, or monthly premiums to the insurer for a long period. The payments may involve a heavy financial burden on the insured party at some points in time, leading to discontinuation of various PI policies. In addition, from time to time insurance companies change the premiums and/or other terms of new PI policies, in accordance with changes in the occurrence rates of the liability, in relevant mortality tables, in interest rates, in market conditions, and for other reasons. Prior art in PI's bear close resemblance to—and may be connected to—personal insurance policies, because they too are issued under prior art to specific holders, or naming specific persons thereunder whose identity particulars determine the terms of the contracts, and therefore cannot be changed under such contract terms. Such instruments are therefore not freely transferable nor are they tradable.

Until now it is not possible—nor has it been suggested in the literature or in patents—to issue PI's, insurance policies and similar instruments by insurers, pension funds or other relevant financial entities, which will not include at the time of such issuance, the names of its holders, and/or of its beneficiaries and/or of the insured persons there under.

The current Invention introduces PI's which are issued with unknown identities for the Holder, and/or the Beneficiaries and/or the Insured Persons. Under the terms and applications of the new PI's, any Holder may at a later stage specify names of holder, beneficiaries and insured person as provided by the terms and conditions of any of such relevant instruments transforming them to standard policies. Under the natural application of those PI's, during the period between the time of the issuance of the anonymous instruments and the time on which the relevant specific names under the instruments are provided, the instruments may be freely and unrestrictedly transferable and tradable from holder to holder for consideration or otherwise at market terms.

The present invention is intended to open the market to the purchases of such instruments to buyers, who may not be the beneficiaries thereunder, and to facilitate trading therewith as presented and further elaborated herebelow.

The present invention advantageously introduces, and provides innovative improvements, additions and new elements, to be utilized commercially in wide fields of life related pension programs and health maintenance policies. The commercial and economic advantages of the present invention will be further elaborated as we progress with the detailed description thereof.

### SUMMARY OF THE INVENTION

The invention introduces innovative elements to life related annuities, pension fund contracts and similar instruments (PI's) carried out under prior art, by transforming such instruments from PI's issued permanently to a specific holder and priced according to a specific contracted insured person, Into PI contracts issued initially to anonymous holders, without any specific insured persons or beneficiaries.

Such innovative contracts may be converted by any Holder thereof up to a specified expiration date to contracts the terms of which are similar to those found in prior art, by the holder identifying at such time the specific Insured Person, the Beneficiaries and possibly also the Holder of the specific contract, who are identified under prior art contracts already at the original time of the issuance of such contracts.

The initial purchase of such contract typically involves the payment of an advance payment on account of the contract, and the balance of the payments is due if and after the initial contract is transformed into the final contract, which additional payments are determined in accordance with the particulars of the specifically identified insured persons and other relevant considerations, as per stipulated contractually price group lists to which such identified insured person may belong.

During the period of time until such identification of the relevant persons under said contracts takes place, the contracts may change hands by selling or otherwise transferring the rights there under from one anonymous holder to another one, and so on until the contract is activated or expired.

The nameless, impersonal, generic nature of this novel financial instrument, with or without the transferability and tradability of said contract, all of which not existing under prior art, provide advantages to both the holders and the issuers of such contracts as follows:

To buyers and holders from time to time, which may secure a future commitment of the issuers to be bound by terms pre-agreed in advance, and may resell the contract in the open market for any reason, including the need for liquidity and specifically in the case of a deterioration of their health conditions. Under the latter scenario, the fair market value of the still nameless contract, represented by its terms and the advance payment effected, the market conditions Is lower than the value of the contract a healthy person. Thus, one of the main psychological and practical disadvantages of a regular PI contract—the possibility of long payments followed by a short period of revenues due to bad health—is eliminated.

To Employers, who may wish to secure by payment of advance payment a number of nameless contracts to be allocated and transferred by them on some dates in the future to a specific number of their employees, which at the time of issuance of purchase of such contracts, the Employers are not yet aware, or have not yet decided on their specific identities. This is a very common situation, under which only a certain number of the employees currently on the payroll will remain there in a few years.

To the Issuers of the contracts a new marketing venue is opened up, promising through Innovative advance payment schedules, expiration dates of the contracts and other pricing elements, a controllable stream of cashflow and activated contracts. Issuers can also use the new instruments to hedge against open mortality-related positions in their own portfolios.

To Institutions which would be welcome to participate in this new market, once the contracts are freely tradable.

### DETAILED DESCRIPTION OF PREFERRED EMBODIMENTS

Definitions and Abbreviations

Life Related Contract (“LRC”)—is any and all alternatives, variations and kinds of prior art of Life Related Contracts, Annuities, Pension arrangements, combinations and/or integration of any of such different schemes, other financial instruments effectively providing insurance etc, which may take into account elements relating to life expectancy probabilities, mortality tables, health related statistical tables or equivalents (“Statistical Tables”) as part of the considerations, pricing of premium, payments of insurance proceeds or any other monetary and/or financial components under an LRC contract.

Pension Instruments (“PI′, “PI's”) are the subpopulation of LRC's relating to annuities, pensions and other life-related instruments that may provide payments or other monetarily compensations an/or considerations to the beneficiaries thereunder in accordance with the terms thereof, not as a result of occurrence of insurance incidents or events typically included in Insurance Policy/Risk Policy or equivalent, such as a death of the Insured Person, injury or similar, but as a result that such event which may or may not relate to life expectation has not occurred before certain date and/or occurrence of other conditions stipulated in such contracts. This differs from an Insurance Policy/Risk Policy of which the proceeds are paid if and when an event (such as the death of the Insured Person) does occur.

Anonymous Pension Instrument (“API”)—is the instrument described under this invention, which may relate to any or all PI's. The instruments may be anonymous, and/or transferable and/or tradable as described below.

The specific PI to which a specific API relates to is the Underlying PI.

The Issuer of the API (“API Issuer”) is an entity willing and able to undertake on the basis of the API, the unconditional commitment of an Underlying PI as a provider. Prime API issuers will include insurance providers such as an insurance company, pension fund, policy underwriter and other financial institutions, as also their assignees. API Issuers may be expected to include those currently issuing LRC's and PI's in particular, who may diversify their activities to the issue of API's on PI's as underlying assets.

Other participants besides the API Issuer are the holder of the API (“API Holder”), the insured person (“Insured Person”), and the beneficiary or beneficiaries of the API (“API Beneficiary”).

The API Holder is the initial buyer of the API or any subsequent transferee thereof, who holds the API in possession at any given time. The initial API Holder, or any subsequent API Holder may be anonymous, as provided (if provided) under the API Trade Rules.

The Insured Person is the person whose particulars and condition conform with the terms and conditions of the API and/or of the Underlying PI. Such particulars and conditions serve as basis for the financial elements and calculations, e.g., the premium consideration, the compensation payable under the PI etc., and whether the person allowed to enter into the PI since said person complies with the Pre-Agreed Qualification Conditions (PAQC) of the API, as defined below.

The API Beneficiary is the party or parties in the API or in the PI, to whom the financial compensation is payable under the terms of the PI.

All and/or any two of the above API Holder, API Beneficiary and Insured Person may be the same person or entity at any given times, or all along.

Pre-Agreed Qualification Conditions (“PAQC”)—are the conditions in the API, or attached to the API, or available otherwise, defining the affiliation of the Insured Person to a group to which that Insured Person belongs. PAQCs may include various categories, e.g., Age at Activation Date (or being under a minimum age); Gender, Smoking/No Smoking; Country of residence or origin; special risk factors (e.g., risky work, hobbies, prior illness history etc.); and other factors and groupings covered by Statistical Tables and/or criteria and/or considerations customarily considered in the pricing of PI's in prior art and other criteria and considerations deemed relevant. An API may be limited to a specific set of PAQCs, or it may apply to more than one set of PAQCs. In the latter case, the premium payable under the LRC may be different for each PAQC set or for some PAQC sets.

Termination Date—the date the API terminates, which is the Activation Date or the Expiration Date, whichever comes first.

Trading Rules—Each API may or may not incorporate rules governing transferability and trade of the API. Such Trading Rules may include e.g., specification of allowed transferee, allowed Insured Person, various time limitations on transfer, identification and/or registration of transfer and/or API, etc. Legitimate transfers will have to abide by said Trading Rules.

UNDER THE PREFERRED EMBODIMENT OF THE INVENTION

The Initial API Holder purchases the API from the API Issuer, against a stipulated sum of money, in a lump sum or in installments, in accordance with the terms of the API (“Advance Premium”).

The Advance Premium may be different for two APIs on identical PI's, if the two APIs include different PAQCs and/or if the dates of expiry are different and/or according to age parameters in the LRC (e.g., retirement age, termination age etc.,).

The API may be transferred from time to time, according to the Trading Rules from the Initial API Holder to a subsequent API Holder and such API may be further transferred from subsequent API Holder to another subsequent API Holder and so forth, all according to the Trading Rules.

Any API Holder may activate the API, or transfer it according to the Trading Rules to a subsequent API Holder until its Expiration Date.

By paying the Advance Premium the Initial API Holder obtains an unconditional commitment of the API Issuer and/or of an assignee thereof, to enter into the Underlying PI on any Insured Person complying with the PAQC, upon the Activation of the API. The time of Activation (“Activation Date”), may be no later than a stipulated date of expiration of the API (“Expiration Date”). The Activation may be done by the Initial API Holder or may be done by any subsequent API Holder.

The Activation Procedure may take different forms such as—written, notarized, verbal, online, automatic, by proxy and any other relevant form specified in the API or agreed upon.

Upon activation the API, the holder named there under is committed to pay the premium payments under the terms of the Underlying LRC, which may be in a lump sum, in periodic payments, or any other arrangement pre-agreed in the API specific terms and conditions.

The specific terms of the relevant API will of course take Into account the Advance Premium made already in pricing the additional payments due under the Underlying PI. In most cases, the higher the Advance Premium is, the lower would be subsequent payments due under the Underlying PI by the PI Holder after the Activation Date.

Upon the activation the API and before the Underlying PI enters into effect, the API Holder must identify the Insured Person and the API Beneficiary. Thereupon, provided that said identified Insured Person complies with the PAQC, the API will be satisfied and the Underlying PI will enter into effect, pursuant to the terms and conditions thereof.

During the period commencing with the issuance of the API and the Termination Date the Insured Person and API Beneficiary may remain anonymous. Hence, the initial API Holder and any subsequent API Holder may freely transfer the API in accordance with the Trading Rules. Furthermore, the API Holder may also remain anonymous if no registration is required by the Trading Rules.

The API may stipulate a minimal time interval (“API Time Gap”) between the Activation Date (at which the Insured Person is identified) and the time at which the entitlement of the API Beneficiary to receive compensation comes into effect.

Alternatively, the API Time Gap may be between an irrevocable notice to activate and actual Activation Date, or other time gaps stipulated for providing certain precautions to the API Issuers against advantageous identification of Insured Persons. The API may stipulate certain selection procedures and/or other pre-qualifications, which may include medical examination of the Insured Person, once that person is identified and prior to entry into PI to determine if the person in question fits and satisfies the PAQC of the API.

Pricing of prior art PI's depends, on data and other information pertaining to the person entering into a PI, as well as inter alia on the Statistical Tables relevant to the population group to which the person entering the PI belongs. Similarly in this Invention, since the specific Insured Person is unknown at the time of issuance of the API, it is likely that the pricing of the Underlying PI and of the API may include a range of Premium Price List for Pre-defined Population Groups. The specific premium of the activated Underlying PI will be determined in accordance with the premium relevant to the Population Group, which fits the Insured Person identified upon activation the API. That is why when that person is identified; the data and other information of said identified Insured Person must fit to one of the Groups defined in advance by the PAQC. An API may or may not be limited to one or more Population Groups.

For the purpose of illustration only, the API may provide the following PAQCs for allocating of specific named Insured Person:

| | | Age at | |
|---|---|---|---|
| Group | Gender | Activation Date | Smoking |
| 1 | M | 45 | Y |
| 2 | M | 45 | N |
| 3 | M | 55 | Y |
| 4 | M | 55 | N |
| 5 | F | 45 | Y |
| 6 | F | 45 | N |
| 7 | F | 55 | Y |
| 8 | F | 55 | Y |

In this example, in order to receive the API terms of Group 3, the Insured Person would have to be a smoking 55 years old male. For each of the above groups, there may be different alterative terms per API Time Gap (e.g., 5, 7, 10 years etc.).

The specific terms of the relevant API takes into account the paid up Advance Premium, in pricing of the additional payments due under the PI. Since up to the Termination Date the API Beneficiary and the Insured Person may be nameless, such API may be freely traded from API Holder to subsequent ones, at prices, which may reflect, the built-in benefits accumulated until such transfer. Such benefits may be attributable to the Advance Premium paid, shorter time to Expiration Date, changes in the market conditions (such as mortality schedule of the Population Groups), or changes in other relevant parameters in pricing of Premium such as interest rate, volatility within the Population Groups etc.

Since said API may be freely tradable, it may also be purchased by a API Issuer as a hedge against its obligations under a API issued by him, or for other reasons and may be subject to syndication and reinsurance arrangements, similarly to frequent practices in prior art trading systems and methods in the insurance business.

It is expected that the Insured Persons will usually be people who are generally healthy on the Activation Date. However, so long as diseases and/or infirmities are covered by relevant Statistical Tables and provided the API PAQCs allowed such diseases and/or infirmities (e.g., by a specific Group Price), persons belonging to such groups may also be included.

It is expected that usually Holder, Insured Person and Beneficiary will be identified on the Activation Date. However, this patent includes also an alternative wherein the Insured Person is identified, while the Beneficiary and/or Holder remains anonymous for some further interval of time, during which the API may still be traded, albeit with a specific Insured Person.

It is worth noting that barring a sharp global reduction in life expectancy or a mistake or forgetfulness by the last Holder, an API should be constructed by the Issuer in such a manner that it (the LPI) will be activated. If for health reasons the Holder faces an API which is not worth activating by him, it is worth activating to someone else and thus will be sold to that other someone—a healthy person—and activated by the new Holder. This is essentially the economics of an API, whereby the first payment is an advance, and the instrument will be activated. This is a major conceptual difference from current PI's, which are specific to the Insured Person, and thus their eventuality changes with the health condition of the Insured Person (not to mention states of nature where he dies).

The market for API's

Employers:

The invention enriches the spectrum of employers benefit to employees and reduces their exposure against future risks.

The invention will facilitate for employers/companies securing a number of API's to be provided by them to specific part of their employees to be decided not upon issuance of said API's but at some future dates prior to the API's relevant Expiration Dates. The transfer of such API to said employees may take place after additional Advance Premium will be made by the employers on account of the PI. Such additional payments will reduce future payments obligations of said transferees under the terms of the Underlying PI, increasing thereby the benefit transferred to them by the employers.

The anonymity and to some extent the transferability facilitate the trade, thus providing much needed flexibility in PI's, to employers who become less bound by earmarked payments and provides a high likelihood to the API Holder that his investment in the API will not be lost, even if there is a turnover in employees.

Individuals:

Individuals may secure through Advance Premium the right to Underlying PI at terms fixed at the time of issuance of the API, even if in the intervening years there will be changes in life mortality tables, interest rates, or other changes leading to changes in prices and payments. Tradability until the Expiration Date adds the advantage that the individual is now able to readily redeem the API in the open market at its fair market value representing the accumulated accrued benefits thereof, in the event of deterioration in the API Holder health prior to the Activation Date, providing protection of his Advance Premium investment (which is not otherwise available under a standard PI's). As a result, a paramount psychological and practical disadvantage of a regular PI contract—the possibility of long payments made by the Insured Person followed by a health deterioration resulting in a short period of revenues—is eliminated due to the introduction of API's.

API Issuers

To insurers, this invention adds greater richness and versatility by opening a new marketing avenue, attracting new segments of potential clients for future PI's, securing in advance contracts through different and novel Group Pricing of premiums, fixing convenient Expiration Dates, etc in respect of the LRC's offered under prior art

Issuers may issue APIs with specific terms to hedge against open mortality-related positions in their portfolio. The Issuer may rely on the eventuality of the activation of the future PI in respect of API having a substantial Advance Premium, and write APIs to hedge against future open positions, thus controlling the Activation Date, group of Insured Persons and future cash flow. This is a huge advantage, almost impossible to attain at current prior art conditions.

Institutional:

The present invention is intended to open the market of PI's to buyers and short position holders who may not be the beneficiaries thereunder and to facilitate limited trading with such PI's, as presented and elaborated here.

Once trade in APIs is established, institutional investors may want to enter this market Since the value of the APIs is heavily influenced by projections on life expectancy and mortality, institutional investors may gain information or research on mortality probabilities and factoring influencing mortality in different countries. This may open an entirely new venue for institutional research and investment. Institutional players may attain for the first time long and short positions related to mortality of certain population segments, genders and/or country residents.

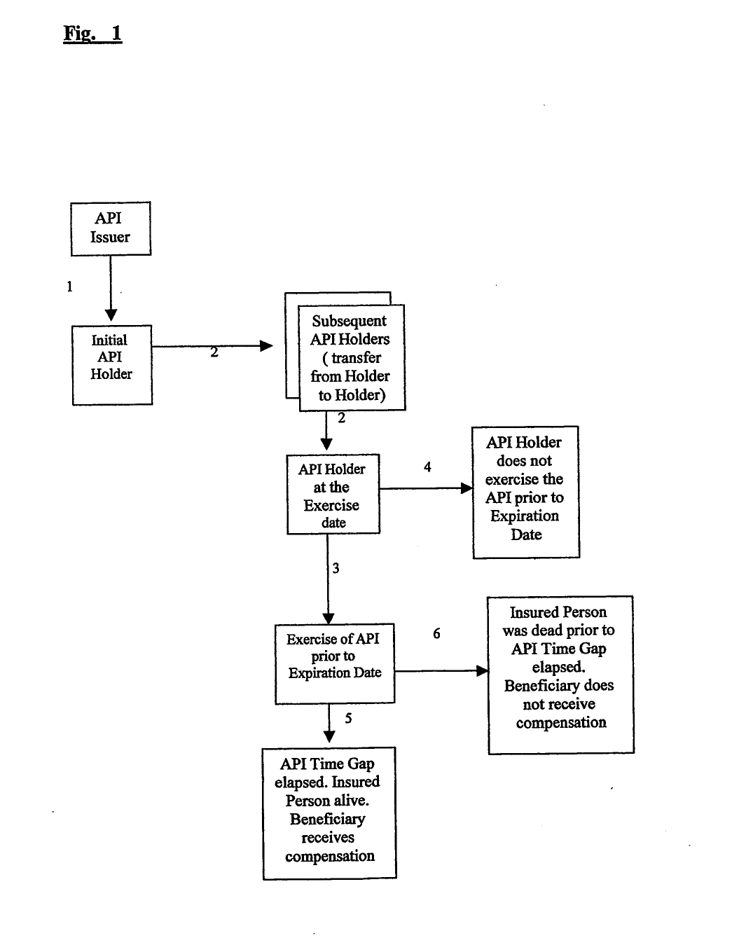

FIG. 1. Is a flowchart of the issue and trade, according to a preferred embodiment of the invention.

At step No. 1 Life Insurance Body (API Issuer) issues and sells an API to an initial nameless buyer (Initial API Holder) against payment of an Advance Premium. Said API relates to a certain life related insurance contract (Underlying LRC) at the terms referred therein.

At step No. 2 the Initial API Holder may sell, transfer, assign or otherwise pass over (“Trading”) the rights and obligations under the API to a subsequent unnamed holder (Subsequent API Holder). The latter may further Trade the API to Subsequent API Holders and so forth, until the API Termination Date. The Trading Terms may be different with respect to each Trading transaction throughout passage of time, as agreed between buyer and seller.

At step No. 3 the API Holder Activates the API at or prior to the Activation Date, complying with the terms required for due activation of said API (PAQC) and the PI, including identification of the Insured Person under the PI, and the PI Beneficiary, Thereupon the Underlying PI becomes effective.

At step No. 4 the API Holder does not activate the API until the Expiration Date, and at such time the API expires without entering into effect of the PI.

At step No. 5 all terms and conditions of the PI become binding and operative between the insurance body, the policy Holder, the Beneficiary, the Insured Person and any other interested party under such LRC, as applicable and customary in any LRC under prior art.

At step No. 6 the API Time Gap has elapsed, the Insured Person is alive, and the Beneficiary starts receiving the consideration from the PI.

At step No. 6A the API Time Gap has elapsed, the Insured Person is no longer alive, and the Beneficiary does not receive the consideration from the PI (subject to this being part of the API Terms).

The above examples and description have of course been provided only for the purpose of illustration, and are not intended to limit the invention in any way. As will be appreciated by the skilled persons, the invention can be carried out in a great variety of ways, employing more than one technique from those described above, all without exceeding the scope of the invention

1. A System or method of issuance and use of new instruments in the fields of life related annuities, pension funds contracts and similar arrangements under prior art (“PI's”), introducing a novelty to the known terms and conditions stipulated in and carried out by insurance companies, pension funds entities, and other financial institutions and entities, base don prior art contracts in forms and substance used in such fields, including:
Issuance and sale of anonymous PI's (“API”) by the API Issuer to an Initial Holder of API for an advance payment (“Advance Premium”), in one payment or more, payable by the Initial Holder to the Issuer on account of the payment to become due under the Underlying PI. The API does not have to specify the names of the Holder, the Insured Person or the Beneficiary at the time of issuance.
On or prior to a specific date (Expiration Date) the Holder will specify and identify the names of the ultimate Holder, the Insured person and the Beneficiary under the API and/or the PI, and any other party which may be pertinent to such API and/or PI. Upon such identification (“Activation”), the Underlying LRC enters into effect and becomes operative, like a PI between Issuer and parties whose names have been specified therein.
If by the Expiration Date, which date may be extended, the API has not been Activated, the API may terminate and may have no effect as of the Expiration Date.

2. A method according to claim 1, further comprising that The Initial Holder may sell, transfer or otherwise assign in whole or in part the API to any subsequent Holder who may also be nameless, and who may also do same sale, transfer or assignment until the Expiration Date or the Activation Date, which ever comes first. Such sale, transfer or assignment may or may not be for a consideration payable by or on behalf of the transferee to the transferor.

3. A method according to claim 1 and/or claim 2, further comprising that the Insured Person to be dully identified on the Activation Date will have to comply with and satisfy certain pre-agreed qualifications conditions (“PAQC”) forming part of the API terms and conditions. Such PAQC may determine to which classes or groups of insurance population (“Insurance Groups”) such Insured persons belongs, which Insurance Group may have affect on the pricing of the payment or premium relating to the Underlying PI. The terms of the API may be different for every Insurance Group, and an API may or may not apply to more than one Insurance Group, with or without different PAQCs for each Insurance Group.

4. A method according to claim 1 and/or claim 2 and/or claim 3, further comprising that the API may stipulate:
A minimal time interval (“API Time Gap”) between the Activation Date and the time at which the entitlement of the API Beneficiary to receive compensation comes into effect, or other time gaps stipulated for providing certain precautions to the API Issuers against advantageous identification of Insured Persons. And/or
Certain selection procedures and/or other pre-qualifications, which may include medical examination of the Insured Person, once that person is identified and prior to entry into PI to determine if the person in question fits and satisfies the PAQC of the API.

5. A method according to claim 2, further comprising that the sale and/or transfer and/or trading with the API will be done in full or partial accordance with a set of rules (“Trading Rules”) to be part of the API relating to the Underlying PI.

6. A method according to claim 1 and/or claim 2, further comprising that the Insured person remains anonymous as provided in claim 1, but the specific identity any of the other interested parties to the API may be specified therein.

7. A method according to claim 1 and/or claim 2, further comprising that upon the Activation of the API on the Activation Date, the Insured Person is identified, while the Beneficiary and/or Holder remains anonymous for some further interval of time, during which the API may still be traded in accordance with the Trading Rules, albeit with a specific Insured Person.

8. A method according to claim 3, further comprising that the API will provide a price lists and other relevant financial elements (“Price List”) for each of the Insurance Groups relating to Underlying PI, which will be binding upon the API Issuer with respect to any dully identified Insured Person belonging to any of such Insurance Groups.

9. A method according to claim 8, further comprising a mechanisms or formula for giving credit, set-off or discount from the relevant Price List, for the Advance Premium paid in respect of the API on account of the Underlying PI, in determining of the balance of payments under such Price List corresponding to the Insurance Group to which any dully identified Insured Person may belong.

10. A method according to claim 1 further comprising of applying the method or system described in claim 1 to all LRC's, including insurance policies and other risk related insurance instruments under which the compensation is due upon the occurrence of an event.

11. A method according to any of the claim 2 through 9 referring and/or further comprising substituting any and all references of PI's to include all forms of LRC's, so that all forms of LRC's are included under API's.

12. A method of issuance, use and trade of API and Underlying LRC, substantially as described and illustrated.

13. A system of issuance, use and trade of API and Underlying LRC, substantially as described and illustrated.
